(19) United States
(12) Patent Application Publication
(10) Pub. No.: US 2008/0200062 A1
(43) Pub. Date: Aug. 21, 2008

(54) Connector for a flexible flat cable

(76) Inventors: Alex Huang, Taichung County (TW); David Tsai, Taichung County (TW)

Correspondence Address: Alex Huang, P.O. Box 2-42 Tanzih, Taichung County, 42799, omitted

(21) Appl. No.: 11/707,543

(22) Filed: Feb. 20, 2007

(51) Int. Cl. H01R 12/24

(52) U.S. Cl. 439/494

(57) ABSTRACT

A connector for a flexible flat cable comprises a clamping seat provided at the front and rear ends thereof with an insertion, terminal recesses and a cover plate respectively, at each of the outer walls of two of the terminal recesses, which are located at the leftmost and rightmost sides, is formed a slot, and on the cover plate being disposed bores, at each of two sides of the clamping seat being arranged a retaining member, a locking member defined at the front end thereof with an inserting segment and snap-on tabs; wherein the retaining member is connected to the clamping seat by using a connecting portion in its intermediate projected section, and is provided at its front and rear ends with a hook and a bent end wall respectively, a groove is formed for spacing the retaining member and the outer side of the clamping seat apart, thereby achieving a secure retaining purpose and preventing the operational fatigue.

### BACKGROUND OF THE INVENTION

1. Field of the Invention

The present invention relates to a connector, and more particularly to a connector for a flexible flat cable that can prevent an imperfect contact because of the shaking thereof.

2. Description of the Prior Arts

Generally, electric connector is applied on the electronic products, for example, a connector for a flexible flat cable is used for a transmitting medium of electronic signal.

Referring to FIGS. 1 and 1A, a conventional connector for a flexible flat cable includes a clamping seat 1 provided at the front end thereof with an insertion 10 and at the rear end thereof with a plurality of terminal recesses 11 and a cover plate 12, and at each of two sides of the clamping seat 1 is arranged a retaining member 13 which is connected to the clamping seat 1 by using a connecting portion 131 in its intermediate projected section and is provided at the front end thereof with a hook 132 and at the rear end thereof with an end wall 133, d a groove 134 is formed between the outer side of the clamping seat 1 and the end wall 133 for spacing the retaining member 13 and the outer side of the clamping seat 1 apart from each other.

However, such a conventional connector for a flexible flat cable still has the following defects that could be improved:

1. The clamping seat is employ the retaining members at two sides thereof to retain the locking member, yet such a retaining structure will cause a fatigue due to repeated operations, because the size of the groove is more than that of the outer side of the clamping seat, and the space of the groove is too small to obtain a sufficient rebounding force.

2. The clamping seat and the locking member are connected together only by means of the terminal slots and the cover plate, hence random disengagement, easy shake and imperfect contact of electricity will occur.

The present invention has arisen to mitigate and/or obviate the afore-described disadvantages.

### SUMMARY OF THE INVENTION

The primary objective of the present invention is to provide a connector for a flexible flat cable, which can utilize a special retaining member to prevent a fatigue after repeated operations, and by way of a positioning and anti-shaking structure, the coupling strength of a clamping seat and a locking member can be greatly enhanced so as to prevent a disengagement.

The connector for the flexible flat cable includes a clamping seat provided at the front end thereof with an insertion and at the rear end thereof with a plurality of terminal recesses and a cover plate, at each of the outer walls of two of the terminal recesses, which are located at the leftmost and rightmost sides respectively, being formed a slot, on the cover plate being disposed a plurality of bores, and at each of two sides of the clamping seat being arranged a retaining member. It is to be noted that the retaining member is connected to the clamping seat by using a connecting portion in its intermediate projected section, and is provided at the front end thereof with a hook and at the rear end thereof with a bent end wall, the size of which is less than that of the outer side of the clamping seat, and a groove is formed between the outer side of the clamping seat and the end wall for spacing the retaining member and the outer side of the clamping seat apart from each other, thereby achieving a secure retaining purpose by pressing and releasing the front end of the hook.

A locking member is defined at the front end thereof with an inserting segment for matingly inserting into the terminal slots, and on the inserting segment are formed a plurality of snap-on tabs which correspond to the bores for engaging with the bores. Furthermore, at each of two sides of the inserting segment is arranged a projection for matingly inserting the corresponding slot, thereby enhancing the retaining strength so as to prevent a slight shaking of the clamping seat and the locking member.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective view of a clamping seat of a conventional connector for a flexible flat cable;

FIG. 1A is a partial enlarged view of FIG. 1;

FIG. 2 is an exploded view of a connector for a flexible flat cable in accordance with the present invention;

FIG. 3 is an exploded view of a clamping seat and a locking member of the connector for the flexible flat cable in accordance with the present invention;

FIG. 3A is a partial enlarged view of FIG. 3;

FIG. 4 is an assembly view of the clamping seat and the locking member of the connector for the flexible flat cable in accordance with the present invention;

FIG. 5 is an exploded view of the connector for the flexible flat cable in accordance with the present invention.

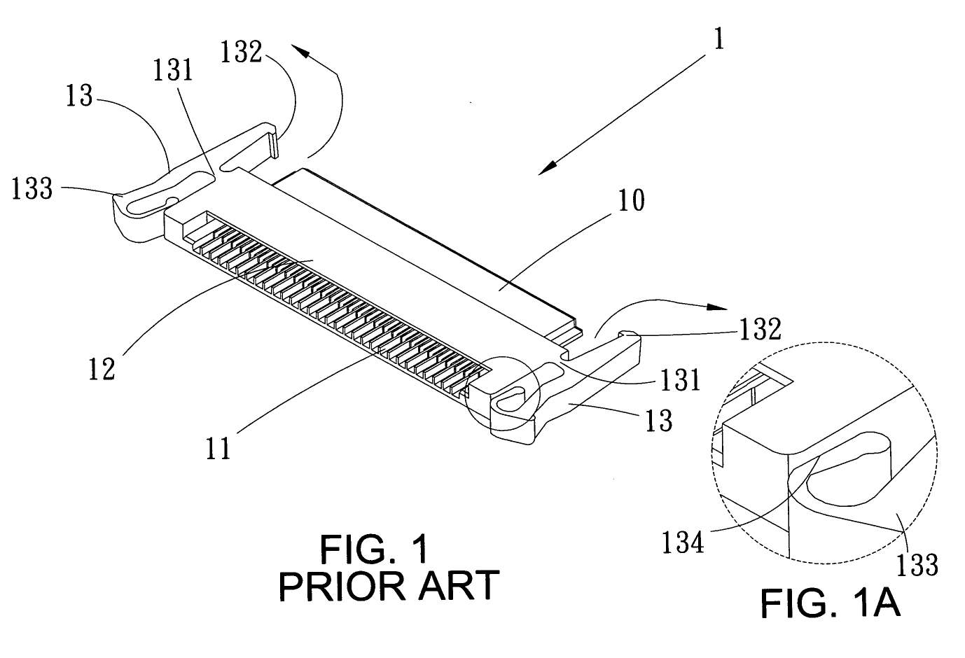

### DETAILED DESCRIPTION OF THE PREFERRED EMBODIMENT

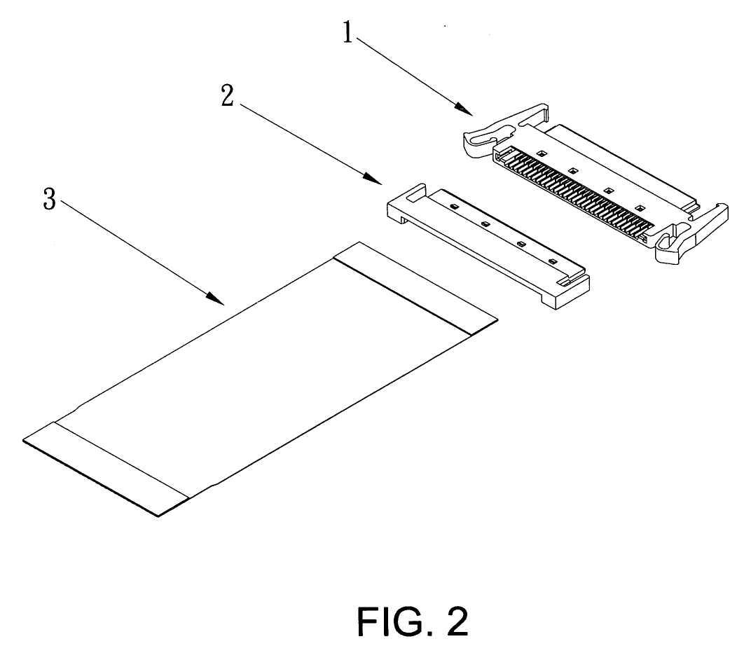

Referring to FIG. 2, a connector for a flexible flat cable in accordance with the present invention is shown and comprises a clamping seat 1, a locking member 2 and a flexible flat cable 3.

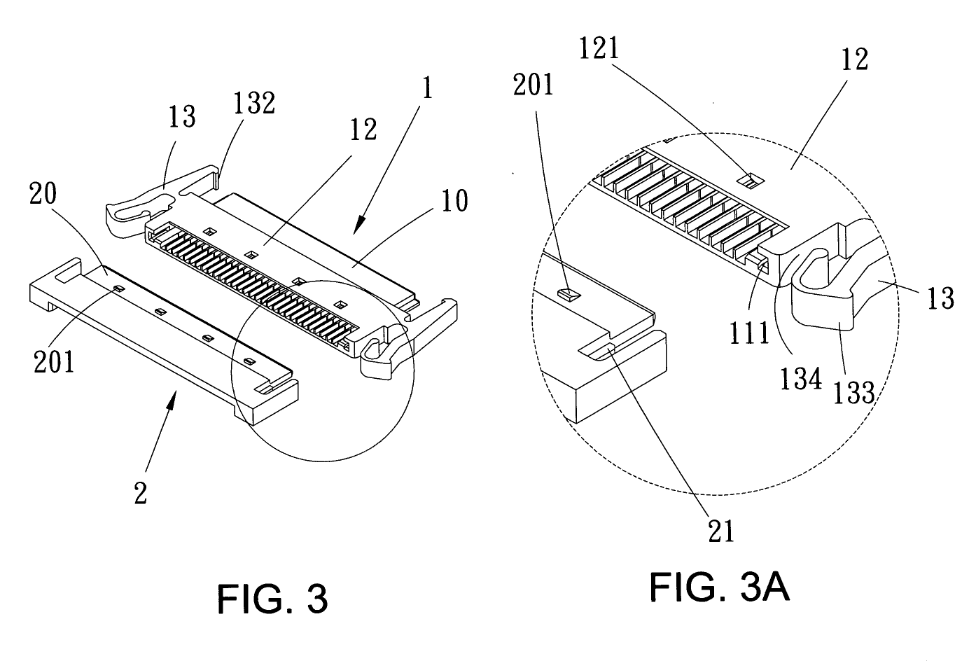

As shown in FIGS. 3 and 3A, the clamping seat 1 is provided at the front end thereof with an insertion 10 and at the rear end thereof with a plurality of terminal recesses 11 and a cover plate 12, at each of the outer walls of two of the terminal recesses 11, which are located at the leftmost and rightmost sides respectively, is formed a slot 111, on the cover plate 12 are disposed a plurality of bores 121, and at two sides of the clamping seat 1 are respectively arranged a retaining member 13. It is to be noted that the retaining member 13 is connected to the clamping seat 1 by using a connecting portion 131 in its intermediate projected section, and is provided at the front end thereof with a hook 132 and at the rear end thereof with a bent end wall 133, the size of which is less than that of the outer side of the clamping seat 1, and a groove 134 is formed between the outer side of the clamping seat 1 and the end wall 133 for spacing the retaining member 13 and the outer side of the clamping seat 1 apart from each other, thereby achieving a secure retaining purpose by pressing and releasing the front end of the hook 132. The locking member 2 is defined at the front end thereof with an inserting segment 20 for matingly inserting into the terminal slots 11, and on the inserting segment 20 are formed a plurality of snap-on tabs 201 which correspond to the bores 121 for matingly engaging with the bores 121. Furthermore, at each of two sides of the inserting segment 20 is arranged a projection 21 for matingly inserting the corresponding slot 111, thereby enhancing the retaining strength so as to prevent a slight shaking of the clamping seat 1 and the locking member 2.

The inner wall of each of the bores 121 is formed in a vertical-plane manner, and the corresponding snap-on tab 201 is constructed in the form of a triangle by its front beveled and rear vertical planes so as to easily insert into the bore 121, and by abutting the rear vertical plane of the snap-on tab 201 against the vertical plane of the inner wall of the bore 121, the snap-on tab 201 will not be randomly pulled out.

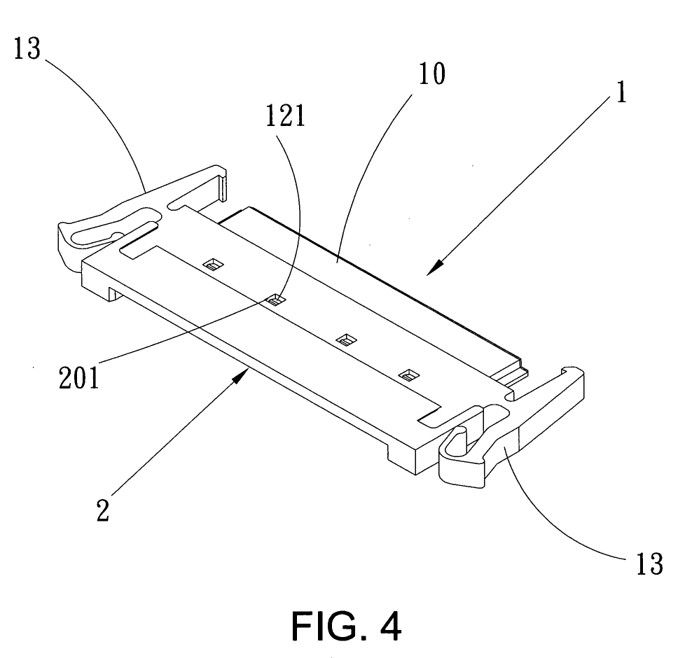

Referring to FIG. 4, while in the assembly of the clamping seat 1 and the locking member 2, the inserting segment 20 at the front end of the locking member 2 is inserted into the terminal slots 10, and the projections 21 at two sides of the locking member 2 are simultaneously inserted into the corresponding slots 111, respectively, thereafter, by using the snap-on tabs 201 in response to the bores 121, the clamping seat 1 and the locking member 2 will be securely assembled together.

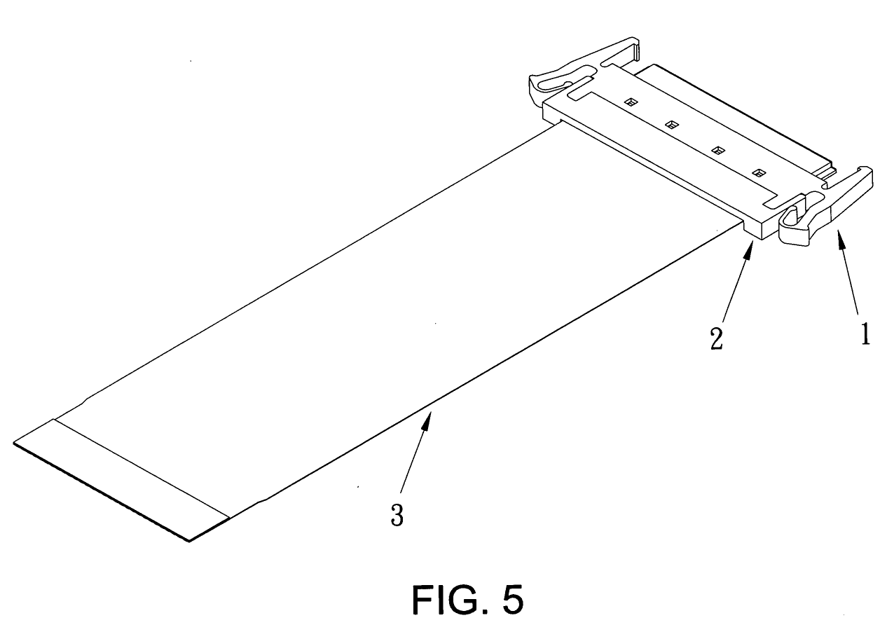

With reference to FIG. 5, in the operation of the connector for the flexible flat cable in accordance with a preferred embodiment of the present invention, one end of a flexible flat cable 3 is coupled to the locking member 2 with which the clamping seat 1 is connected so as to form a complete electrical connection, such that while in use, the connection strength of the clamping seat 1 and the locking member 2 will be greatly improved for the prevention of break and disengagement.

The invention is not limited to the above embodiment but various modifications thereof may be made. It will be understood by those skilled in the art that various changes in form and detail may made without departing from the scope and spirit of the present invention.

What is claimed is:

1. A connector for a flexible flat cable comprising:
a clamping seat provided at the front end thereof with an insertion and at the rear end thereof with a plurality of terminal recesses and a cover plate, and at each of two sides of said clamping seat being arranged a retaining member;
a locking member defined at the front end thereof with an inserting segment for matingly inserting into said terminal slots;
wherein said retaining member is connected to said clamping seat by using a connecting portion in its intermediate projected section, and is provided at the front end thereof with a hook and at the rear end thereof with a bent end wall, a groove is formed between the outer side of said clamping seat and said end wall for spacing said retaining member and the outer side of said clamping seat apart from each other, thereby achieving a secure retaining purpose by pressing and releasing the front end of said hook.

2. The connector for the flexible flat cable as claimed in claim 1, wherein at each of the outer walls of two of said terminal recesses, which are located at the leftmost and rightmost sides respectively, is formed a slot, and at each of two sides of said inserting segment is arranged a projection for matingly inserting the corresponding slot.

3. The connector for the flexible flat cable as claimed in claim 1, wherein on said cover plate are disposed a plurality of bores, and on said inserting segment is formed a plurality of snap-on tabs which correspond to said bores.

4. The connector for the flexible flat cable as claimed in claim 1, wherein the inner wall of each of said bores is formed in a vertical-plane manner, and the corresponding snap-on tab is constructed in the form of a triangle by its front beveled and rear vertical planes.
